(19) United States
(12) Patent Application Publication
(10) Pub. No.: US 2026/0282001 A1
(43) Pub. Date: Sep. 17, 2026

(54) TECHNIQUES FOR SPATIAL QUASI CO-LOCATION RELATIONSHIP FOR ANALOG BEAMFORMING WITH DISCRETE ANTENNAS

(71) Applicant: QUALCOMM Incorporated, San Diego, CA (US)

(72) Inventors: Vasanthan RAGHAVAN, West Windsor Township, NJ (US); Juergen CEZANNE, Ocean Township, NJ (US); Jung Ho RYU, Englewood Cliffs, NJ (US); Kiran VENUGOPAL, Green Brook, NJ (US); Junyi LI, Greentown, PA (US)

(21) Appl. No.: 19/075,954

(22) Filed: Mar. 11, 2025

(51) Int. Cl. H04W 72/044; H01Q 3/28; H01Q 3/36; H04W 72/51

(52) U.S. Cl. CPC H04W 72/046; H01Q 3/28; H01Q 3/36; H04W 72/51

(57) ABSTRACT

Various aspects of the present disclosure generally relate to wireless communication. In some aspects, a user equipment (UE) may transmit, to a network node, signaling indicating an analog beamforming capability associated with the UE. The UE may receive, from the network node, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights. Numerous other aspects are described.

### FIELD OF THE DISCLOSURE

Aspects of the present disclosure generally relate to wireless communication and specifically relate to techniques, apparatuses, and methods associated with a spatial quasi co-location relationship for analog beamforming with discrete antennas.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Efficiencies in throughput, signal strength, or other signal properties may be achieved through analog beamforming. For example, to implement analog beamforming, a transmitting device (e.g., a network node or a user equipment (UE)) may modulate and shift the amplitudes or phases associated with signals transmitted via a set of antenna elements relative to each other (e.g., by manipulating a phase shift, a phase offset, an amplitude, or other parameters) to generate one or more transmit beams, and a receiving device may generate one or more corresponding receive beams. For example, a beam may include a directional transmission of a wireless signal toward a receiving device or a transmission that is otherwise steered in a desired direction or a directional reception of a wireless signal from a transmitting device. Additionally, or alternatively, a beam may include a direction associated with such a directional transmission or directional reception, a set of directional resources associated with a signal transmission or signal reception (e.g., an angle of arrival, a horizontal direction, or a vertical direction), or a set of parameters or resources associated with a directional signal. Analog beamforming occurs at a radio frequency (RF) corresponding to over-the-air communication in a wireless communication system, in contrast to digital beamforming that occurs at a baseband frequency.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include transmitting, to a network node, signaling indicating an analog beamforming capability associated with the UE. The method may include receiving, from the network node, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights.

Some aspects described herein relate to a method of wireless communication performed by a network node. The method may include receiving, from a UE, signaling indicating an analog beamforming capability associated with the UE. The method may include transmitting, to the UE, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to a UE. The UE may include a processing system. The processing system may include one or more processors and one or more code-storing memories coupled with the one or more processors. The processing system may be configured to cause the UE to transmit, to a network node, signaling indicating an analog beamforming capability associated with the UE. The processing system may be configured to cause the UE to receive, from the network node, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to a network node. The network node may include a processing system. The processing system may include one or more processors and one or more code-storing memories coupled with the one or more processors. The processing system may be configured to cause the network node to receive, from a UE, signaling indicating an analog beamforming capability associated with the UE. The processing system may be configured to cause the network node to transmit, to the UE, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to a non-transitory computer-readable medium that stores a set of instructions for wireless communication by a UE. The set of instructions, when executed by one or more processors of the UE, may cause the UE to transmit, to a network node, signaling indicating an analog beamforming capability associated with the UE. The set of instructions, when executed by one or more processors of the UE, may cause the UE to receive, from the network node, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to a non-transitory computer-readable medium that stores a set of instructions for wireless communication by a network node. The set of instructions, when executed by one or more processors of the network node, may cause the network node to receive, from a UE, signaling indicating an analog beamforming capability associated with the UE. The set of instructions, when executed by one or more processors of the network node, may cause the network node to transmit, to the UE, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to an apparatus for wireless communication. The apparatus may include means for transmitting, to a network node, signaling indicating an analog beamforming capability associated with the UE. The apparatus may include means for receiving, from the network node, a reference signal configuration in accordance with the analog beamforming capability associated with the UE, wherein the reference signal configuration indicates a spatial QCL relationship between one or more reference signals for learning beam weights and one or more transmissions that use the beam weights.

Some aspects described herein relate to an apparatus for wireless communication. The apparatus may include means for receiving, from a UE, signaling indicating an analog beamforming capability associated with the UE. The apparatus may include means for transmitting, to the UE, a reference signal configuration in accordance with the analog beamforming capability associated with the UE, wherein the reference signal configuration indicates a spatial QCL relationship between one or more reference signals for learning beam weights and one or more transmissions that use the beam weights.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example wireless communication network.

FIG. 2 is a diagram illustrating an example disaggregated network node architecture.

FIG. 3 is a diagram illustrating an example beamforming architecture.

FIG. 4 is a diagram illustrating example beam management procedures.

FIG. 5 is a diagram illustrating an example associated with analog beamforming for discrete antennas.

FIG. 6 is a diagram illustrating an example associated with learning beam weights for analog beamforming with discrete antennas.

FIG. 7 is a diagram illustrating an example associated with a spatial quasi co-location (QCL) relationship for analog beamforming with discrete antennas.

FIG. 8 is a diagram illustrating an example process performed, for example, at a user equipment (UE) or an apparatus of a UE.

FIG. 9 is a diagram illustrating an example process performed, for example, at a network node or an apparatus of a network node.

FIG. 10 is a diagram of an example apparatus for wireless communication.

FIG. 11 is a diagram of an example apparatus for wireless communication.

### DETAILED DESCRIPTION

As described herein, analog beamforming includes techniques that use phase shifters, amplitude controls, or other techniques to co-phase antenna elements to improve radio performance, mitigate path loss, combat fading, increase throughput and reliability, or otherwise improve performance at a desired radio frequency (RF). Analog beamforming is typically used to improve a link budget at millimeter wave (mmWave) frequencies (e.g., in FR2, which includes frequencies from 24.25 gigahertz (GHz) through 52.6 GHz), where communication at high operating frequencies and shorter wavelengths may be impaired by increased blockage, penetration, and path loss. Accordingly, in FR2 or other mmWave frequencies, analog beamforming techniques are often used to transmit and receive directional signals using antennas that are grouped across polarizations in an antenna module design. Although analog beamforming may similarly improve performance at other frequencies, such as frequencies in FR1 (e.g., from 410 megahertz (MHz) through 7.125 GHz) or FR3 (e.g., from 7.125 GHz through 24.25 GHz), extending analog beamforming techniques to such frequencies poses challenges due to the antenna configurations that are typically used at such frequencies. For example, communication in FR1, FR3, or other sub-mmWave frequencies often use planar inverted-F antenna (PIFA) elements, where a PIFA is a compact antenna structure in which a portion of the antenna is folded over itself and grounded to optimize space and enhance performance. Although PIFAs can be designed to support dual polarizations, practical PIFA designs are often monopoles because dual polarized PIFA designs occupy more area within a user equipment (UE) with a constrained form factor and often do not support wideband applications.

Furthermore, constructing antenna groups that can be co-phased to support analog beamforming can be cumbersome, due to significant search and overhead. For example, analog beamforming can be supported with different antenna elements with associated channels that have high cross-correlation coefficients that vary slowly over time. With antenna elements that have high cross-correlation coefficients, analog beamforming coefficients or weights determined at measurement time can then provide a significant array gain during a reasonable time interval following the measurement time. Antenna elements within an antenna module (or panel) typically have high cross-correlation coefficients that support analog beamforming due to antenna elements having spatial proximity and the same or similar directivity patterns and polarizations. However, antenna elements designed for FR1, FR3, or other sub-mmWave frequencies typically do not have high cross-correlation coefficients, and are instead often placed such that associated channels are uncorrelated to achieve a high diversity gain through antenna selection. Accordingly, constructing antenna groups that can be combined to support analog beamforming is considerably more cumbersome at lower frequencies.

Various aspects relate generally to techniques to enable analog beamforming with discrete antennas, such as antenna elements that are associated with different antenna modules, uncorrelated channels, monopoles, or low cross-correlation coefficients, among other examples. Some aspects more specifically relate to techniques for indicating a spatial quasi co-location (QCL) relationship between one or more signals that are used to learn weights to use for analog beamforming and one or more transmissions that use the weights for directional communication. For example, a UE equipped with multiple discrete or uni-polarized antenna elements may be configured to turn off or otherwise disable one or more RF chains, and may combine multiple antenna elements at a desired RF using analog beamforming weights to maintain a downlink or uplink signal strength margin with the remaining RF chains. For example, the UE may combine multiple discrete antennas into one or more virtual antenna modules, and analog beamforming weights may be used to enable phase shifting or amplitude control to co-phase multiple antenna elements over one or more layers.

Accordingly, in cases where a UE has a capability to perform analog beamforming with discrete antennas, some aspects described herein relate to techniques to configure a spatial QCL relationship that allows the UE to learn the appropriate beam weights for one or more reference signals. For example, in some aspects, the UE may signal an analog beamforming capability to a network node, where the analog beamforming capability may include one or more parameters that enable the network node to determine a number of reference signals to configure for the UE to learn beam weights for analog beamforming. For example, in some aspects, the one or more parameters may include a number of layers that supports analog beamforming, a number of antennas that are combined in an RF or analog domain over each layer, a delay between learning beam weights for analog beamforming and programming the beam weights on RF hardware, or a maximum number of discrete antennas that can be used for analog beamforming, among other examples. Furthermore, the network node may indicate a spatial QCL relationship between the configured reference signal(s) and one or more downlink or uplink symbols where the beam weights that are learned according to measurements associated with the one or more reference signals are used for directional transmissions. For example, in some aspects, the network node may indicate one or more transmission configuration indicator (TCI) states associated with the spatial QCL relationship according to the analog beamforming capability of the UE.

Particular aspects of the subject matter described in this disclosure can be implemented to realize one or more of the following potential advantages. In some examples, the described techniques can be used to configure a spatial QCL relationship to enable analog beamforming using discrete antennas at sub-mmWave frequencies. For example, a UE may disable one or more antenna elements or RF chains and combine remaining discrete antennas into one or more virtual antenna modules to enable reduced power consumption or improve performance at a desired RF, and the spatial QCL relationship may enable the UE to learn and apply beam weights using the particular antenna configuration that is constructed to support analog beamforming.

Furthermore, by indicating the analog beamforming capability to the network node, the described techniques can enable the network node to configure the appropriate number of reference signals to learn the beam weights for analog beamforming according to the indicated UE capability, such that beam weights for analog beamforming can be learned according to a channel impulse response (CIR) estimated over the antenna elements to be combined at the RF level to determine the optimal phase shift, amplitude control, or other parameters over an entire frequency allocation. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, mmWave technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

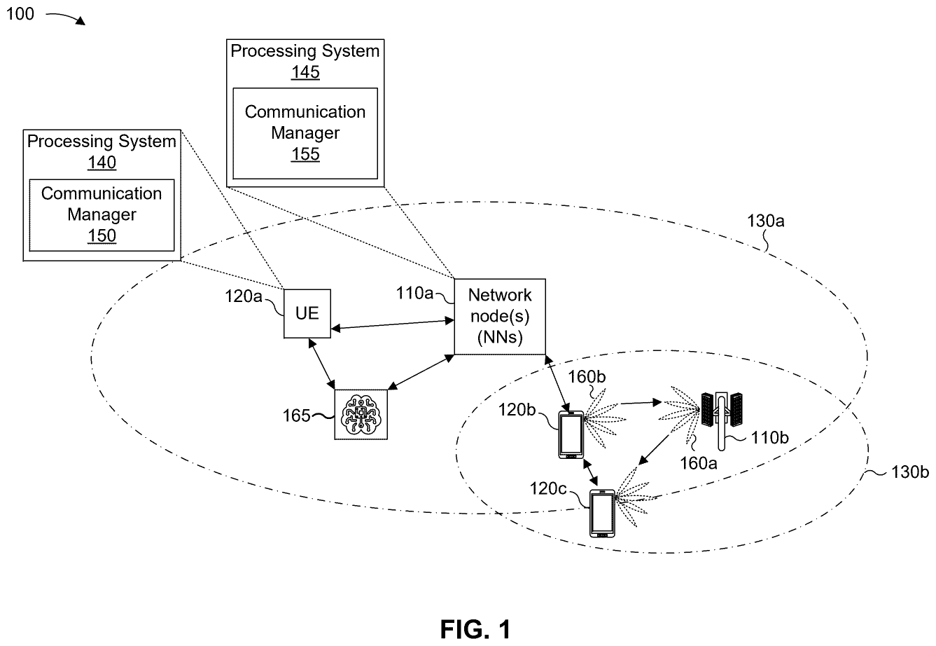

FIG. 1 is a diagram illustrating an example wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation

Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a QCL parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

An antenna panel, an antenna group, or an antenna array may include one or more antenna elements (within a single housing or multiple housings), one or more coplanar antenna elements, one or more non-coplanar antenna elements, or one or more antenna elements coupled with one or more transmission or reception components, such as the processing system 140 or the processing system 145. “Antenna element” refers to single radiating (for example, transmitting) or receiving point included in an antenna array. An antenna array may also be referred to as a “sub-array.” An antenna array may include one or more antenna elements where each antenna element is configured as a single unit for radiating (for example, transmitting or receiving). In some examples, each of the antenna elements of an antenna may include one or more sub-elements for radiating or transmitting or receiving RF signals. A “sub-element” refers to an individual component (e.g., an individually controllable component) within an antenna element, such as an individual radiating unit. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere constructively or destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers or phases of the signal(s) to form one or more beams. The shape of a beam (such as the amplitude, beamwidth, or presence of side lobes) or the direction of a beam (such as an angle of the beam relative to a surface of an antenna array) can be dynamically controlled by modifying the phase shifts, phase offsets, or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Advantages of using a larger number of antenna elements may include providing increased control over parameters for beam generation relative to a smaller number of antenna elements, whereas advantages of using a smaller number of antenna elements may include reducing implementation complexity, or reduced power consumption compared to the use of a larger number of antenna elements. Multiple antenna elements may support multiple-layer transmissions, in which a first layer of a communication (which may include a first data stream) and a second layer of a communication (which may include a second data stream) are transmitted using the same time and frequency resources with spatial multiplexing.

Advancements in antenna designs may be driven by the need for faster data rates, lower latency, or more reliable connectivity in advanced/next-generation systems, such as 6G systems, massive multiple-input multiple-output (massive MIMO) systems, among other examples. For example, the wireless communication network 100 may operate using higher frequency bands, such as millimeter wave frequencies or terahertz (THz) frequencies, which enable faster data transmissions and increased bandwidth. To enable UEs 120 and network nodes 110 to communicate using these higher frequency bands, antennas (or antenna elements) of the UEs 120 and network nodes 110 may be configured to address the increased signal attenuation or limited range associated with these higher frequency bands. For example, a UE 120 or a network node 110 may use advanced beamforming techniques, such as AI/ML-based beamforming techniques (for example, in which an AI/ML model can be used to dynamically adjust beamforming patterns in response to changing network conditions, channel conditions, or UE location, among other examples, to improve signal strength or reduce interference). Additionally, the antennas may have a higher density of antenna elements (e.g., as compared to conventional antenna configurations) to enable more precise beam steering or to increase the quantity of independent beams that can be formed simultaneously using an antenna panel (thereby supporting an increased quantity of simultaneous connections). Additionally, the wireless communication network 100 may include one or more devices that have dynamically configurable antenna panels or antenna elements (for example, for an intelligent reflecting surface (IRS) or a reconfigurable intelligent surface (RIS)) to improve coverage and signal strength.

Further efficiencies in throughput, signal strength, or other signal properties may be achieved through beam refinement. For example, the network node 110 may be capable of communicating with the UE 120 using beams (for example, beam(s) 160a) of different beamwidths. In some examples, the network node 110 may be configured to utilize a wider beamwidth beam (for example, a beam having a larger spatial spread in terms of array gain) to communicate with the UE 120 when the UE 120 is in motion or for initial beam acquisition because wider coverage may increase the likelihood that the UE 120 remains in coverage of the network node 110 while communicating using the wider beam. Conversely, the network node 110 may use a narrower beamwidth beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, an L1 measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

In some examples, a UE 120 or a network node 110 may use an inference model (for example, an AI/ML model) to obtain one or more inferences or predictions for beamforming. An output of the inference model may include a codebook based spatial domain selection or prediction (for example, that indicates one or more predicted measurement values for one or more beams) or a non-codebook based spatial domain selection or prediction (for example, that indicates one or more parameters for a beam, such as a point-direction, an angle of departure (AoD), or an angle of arrival (AoA), among other examples). The UE 120 or the network node 110 may configure one or more antenna elements to form one or more beams in accordance with the output of the inference model.

In some aspects, the UE 120 may include a communication manager 150. As described in more detail elsewhere herein, the communication manager 150 may transmit, to a network node 110, signaling indicating an analog beamforming capability associated with the UE 120; and receive, from the network node 110, a reference signal configuration in accordance with the analog beamforming capability associated with the UE 120, wherein the reference signal configuration indicates a spatial QCL relationship between one or more reference signals for learning beam weights and one or more transmissions that use the beam weights. Additionally, or alternatively, the communication manager 150 may perform one or more other operations described herein.

In some aspects, the network node 110 may include a communication manager 155. As described in more detail elsewhere herein, the communication manager 155 may receive, from a UE 120, signaling indicating an analog beamforming capability associated with the UE 120; and transmit, to the UE 120, a reference signal configuration in accordance with the analog beamforming capability associated with the UE 120, wherein the reference signal configuration indicates a spatial QCL relationship between one or more reference signals for learning beam weights and one or more transmissions that use the beam weights. Additionally, or alternatively, the communication manager 155 may perform one or more other operations described herein.

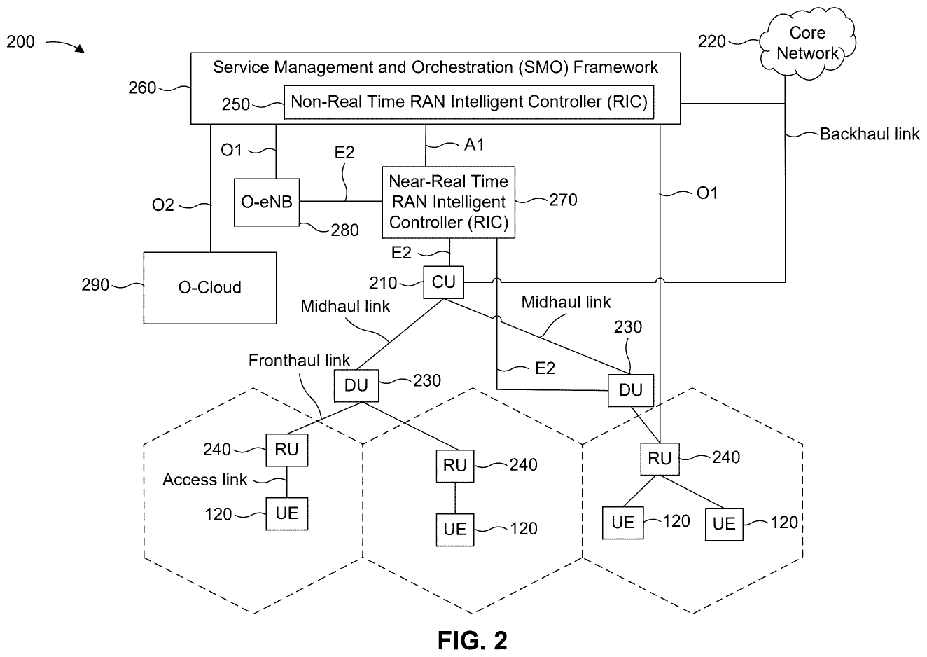

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and

Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

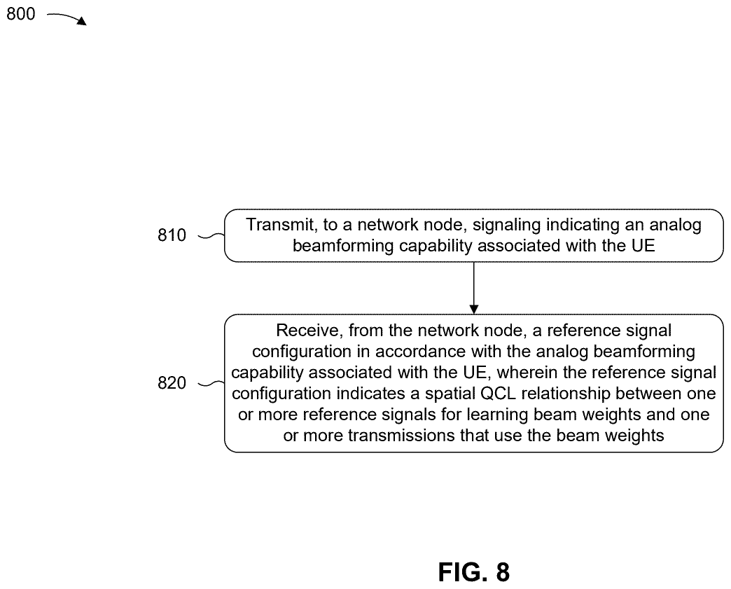

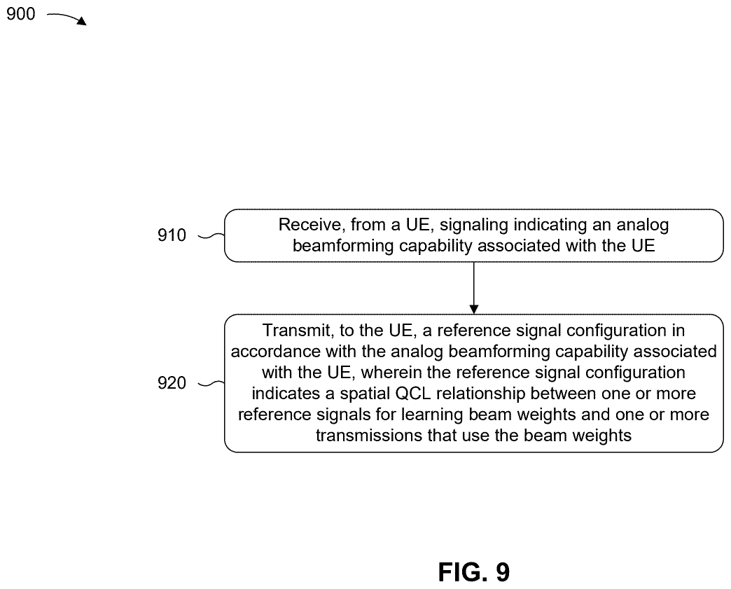

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with a spatial QCL for analog beamforming with discrete antennas, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

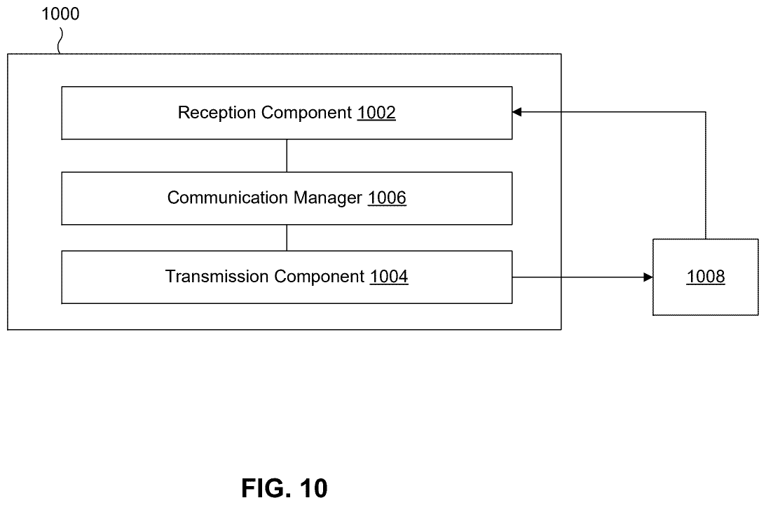

In some aspects, the UE 120 includes means for transmitting, to a network node 110, signaling indicating an analog beamforming capability associated with the UE; or means for receiving, from the network node, a reference signal configuration in accordance with the analog beamforming capability associated with the UE 120, wherein the reference signal configuration indicates a spatial QCL relationship between one or more reference signals for learning beam weights and one or more transmissions that use the beam weights. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

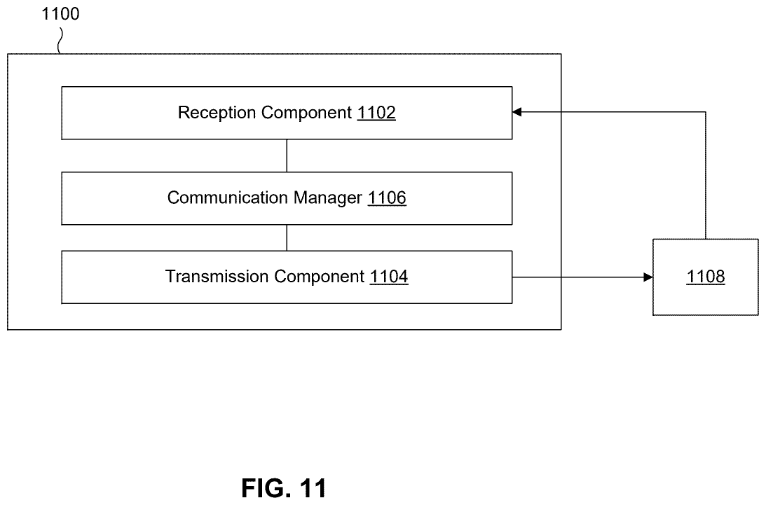

In some aspects, the network node 110 includes means for receiving, from a UE 120, signaling indicating an analog beamforming capability associated with the UE 120; or means for transmitting, to the UE 120, a reference signal configuration in accordance with the analog beamforming capability associated with the UE 120, wherein the reference signal configuration indicates a spatial QCL relationship between one or more reference signals for learning beam weights and one or more transmissions that use the beam weights. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

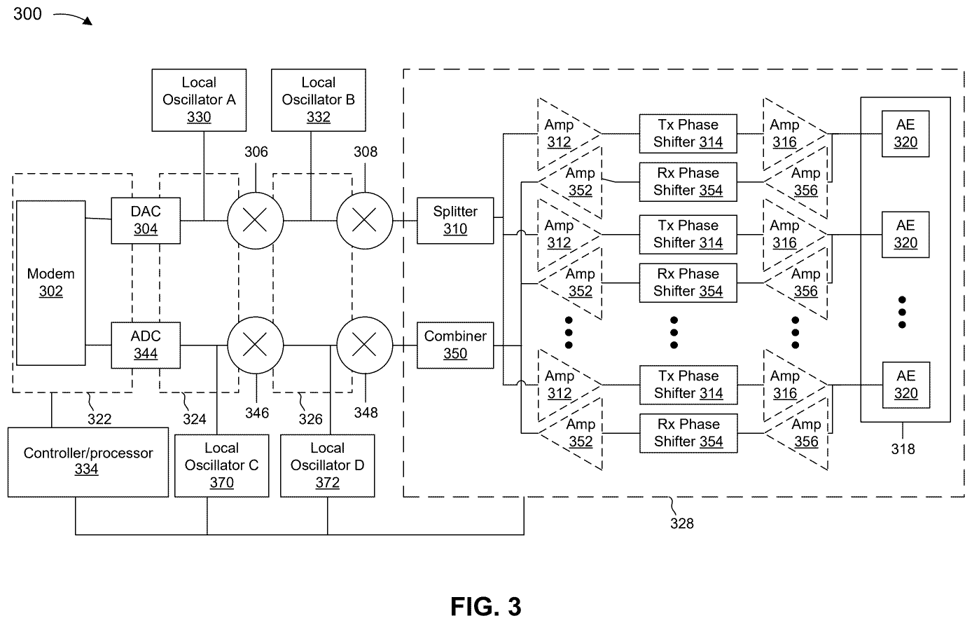

FIG. 3 is a diagram illustrating an example beamforming architecture 300. In some aspects, beamforming architecture 300 may be implemented in a transmitting device (e.g., a first wireless communication device, UE 120, or network node 110) or a receiving device (e.g., a second wireless communication device, UE 120, or network node 110), as described herein.

FIG. 3 illustrates example hardware components of that may be used for antenna element selection or for beamforming for transmission of wireless signals. There are numerous architectures for antenna element selection and implementing phase shifting, only one example of which is illustrated in FIG. 3. The beamforming architecture 300 includes a modem (modulator/demodulator) 302, a digital to analog converter (DAC) 304, a first mixer 306, a second mixer 308, and a splitter 310. The beamforming architecture 300 also includes multiple first amplifiers 312, multiple phase shifters 314, multiple second amplifiers 316, and an antenna array 318 that includes multiple antenna elements 320.

Transmission lines or other waveguides, wires, or traces are shown connecting the various components to illustrate how signals to be transmitted may travel between components. Reference numbers 322, 324, 326, and 328 indicate regions in the beamforming architecture 300 in which different types of signals travel or are processed. For example, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog RF signals travel or are processed. The architecture also includes a local oscillator A 330, a local oscillator B 332, and a controller/processor 334. In some aspects, controller/processor 334 may be included in the processing system 145 of the network node 110 or the processing system 140 of the UE 120 described above in connection with FIG. 1.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 processes and generates digital baseband signals and may also control operation of the DAC 304, first and second mixers 306, 308, splitter 310, first amplifiers 312, phase shifters 314, or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 or the controller/processor 334 may adjust the frequency of local oscillator A 330 or the local oscillator B 332 so that a desired IF or RF frequency is produced and used to facilitate processing and transmission of a signal within a desired bandwidth.

In the illustrated beamforming architecture 300, signals upconverted by the second mixer 308 are split or duplicated into multiple signals by the splitter 310. The splitter 310 in beamforming architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312, 316, phase shifters 314, or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312, 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312, 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312, 316 may provide a desired level of positive or negative gain. A positive gain (positive dB) may be used to increase an amplitude of a signal for radiation by a specific antenna element 320. A negative gain (negative dB) may be used to decrease an amplitude or suppress radiation of the signal by a specific antenna element. Each of the amplifiers 312, 316 may be controlled independently (e.g., by the modem 302 or the controller/processor 334) to provide independent control of the gain for each antenna element 320. For example, the modem 302 or the controller/processor 334 may have at least one control line connected to each of the splitter 310, first amplifiers 312, phase shifters 314, or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 or the controller/processor 334 may have at least one control line connected to each of the phase shifters 314 and which may be used to configure the phase shifters 314 to provide a desired amount of phase shift or phase offset between antenna elements 320.

In the illustrated beamforming architecture 300, RF signals received by the antenna elements 320 are provided to one or more first amplifiers 356 to boost the signal strength. The first amplifiers 356 may be connected to the same antenna arrays 318 (e.g., for time division duplex (TDD) operations). The first amplifiers 356 may be connected to different antenna arrays 318. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 or 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352, 356 is present but not the other.

In the illustrated beamforming architecture 300, signals output by the phase shifters 354 (via the amplifiers 352 when present) are combined in combiner 350. The combiner 350 in beamforming architecture 300 combines the RF signal into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, it may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 are input into an ADC 344 for conversion to digital signals. The digital signals output from ADC 344 are input to modem 302 for baseband processing, such as decoding, deinterleaving, or similar operations.

The beamforming architecture 300 is given by way of example only to illustrate an architecture for transmitting or receiving signals. In some cases, the beamforming architecture 300 or each portion of the beamforming architecture 300 may be repeated multiple times within an architecture to accommodate or provide an arbitrary number of RF chains, antenna elements, or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, or modems. For example, a single UE 120 may include two, four, or more antenna arrays for transmitting or receiving signals at different physical locations on the UE 120 or in different directions.

Furthermore, mixers, splitters, amplifiers, phase shifters and other components may be located in different signal type areas (e.g., represented by different ones of the reference numbers 322, 324, 326, 328) in different implemented architectures. For example, a split of the signal to be transmitted into multiple signals may take place at the analog RF, analog IF, analog baseband, or digital baseband frequencies in different examples. Similarly, amplification or phase shifts may also take place at different frequencies. For example, in some aspects, one or more of the splitter 310, amplifiers 312, 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first or or second amplifiers 312, 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer.

The modem 302 or the controller/processor 334 may control one or more of the other components 304 through 372 to select one or more antenna elements 320 or to form beams for transmission of one or more signals. For example, the antenna elements 320 may be individually selected or deselected for transmission of a signal (or signals) by controlling an amplitude of one or more corresponding amplifiers, such as the first amplifiers 312 or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (such as the amplitude, width, or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312, 316 of the multiple signals relative to each other. The controller/processor 334 may be located partially or fully within one or more other components of the beamforming architecture 300. For example, the controller/processor 334 may be located within the modem 302 in some aspects.

As indicated above, FIG. 3 is provided as an example. Other examples may differ from what is described with regard to FIG. 3.

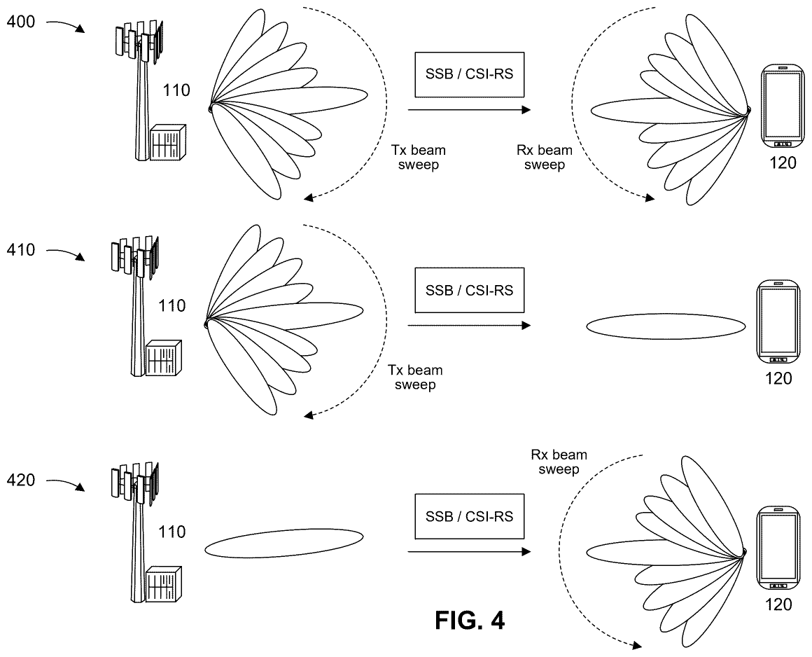

FIG. 4 is a diagram illustrating example beam management procedures 400, 410, and 420 in accordance with the present disclosure. As shown in FIG. 4, example beam management procedures 400, 410, and 420 include a UE 120 in communication with a network node 110 in a wireless network (for example, wireless network 100). However, the devices shown in FIG. 4 are provided as examples, and the wireless network may support communication and beam management between other devices (for example, between a UE 120 and a TRP, DU, or RU, between a mobile termination node and a control node, between an IAB child node and an IAB parent node, or between a scheduled node and a scheduling node). In some aspects, the UE 120 and the network node 110 may be in a connected state (for example, an RRC connected state) when performing the beam management procedure(s).

As shown in FIG. 4, beam management procedure 400 may include the network node 110 and the UE 120 communicating to perform beam management using SSB transmissions or CSI-RS transmissions. The beam management procedure 400 (for example, P1 beam management) may be a beam selection procedure, an initial beam acquisition procedure, a beam sweeping procedure, a cell search procedure, or a beam search procedure. As shown in FIG. 4, in beam management procedure 400, SSBs or CSI-RSs may be configured to be transmitted from the network node 110 to the UE 120. For example, an SSB transmitted by the network node 110 is a single rank (rank-1) periodic reference signal that is always transmitted by the network node 110 to enable initial network acquisition and synchronization in addition to beam selection and beam management. For example, an identifier associated with an SSB may have a one-to-one mapping to a transmit beam used by the network node 110, and the one-to-one mapping may be invariant (for example, static) over time. Additionally, or alternatively, in cases where CSI-RS transmissions are used for the first beam management procedure, the CSI-RSs used for beam selection or beam management may be configured to be periodic (for example, using RRC signaling), semi-persistent (for example, using MAC-CE signaling), or aperiodic (for example, using DCI).

In the beam management procedure 400, the network node 110 may perform a beam sweep over multiple transmit (Tx) beams. The network node 110 may transmit an SSB or a CSI-RS using each transmit beam for beam management. To enable the UE 120 to perform receive (Rx) beam sweeping, the network node 110 may use a transmit beam to transmit (for example, with repetitions) each SSB or CSI-RS at multiple times within the same reference signal resource set so that the UE 120 can perform a beam sweep over multiple receive beams in multiple transmission instances. For example, if the network node 110 supports N transmit beams and the UE 120 supports M receive beams, the SSB or CSI-RS may be transmitted on each of the N transmit beams M times such that the UE 120 may receive M instances of the SSB or CSI-RS per transmit beam. In other words, for each transmit beam of the network node 110, the UE 120 may perform a beam sweep through the receive beams of the UE 120. As a result, the beam management procedure 400 may enable the UE 120 to measure an SSB or CSI-RS on different transmit beams using different receive beams to support selection of one or more transmit/receive beam pair(s) (for example, a pairing between a transmit beam of the network node 110 and a receive beam of the UE 120). The UE 120 may report the measurements to the network node 110 to enable the network node 110 to select one or more beam pairs for communication between the network node 110 and the UE 120.

As shown in FIG. 4, in beam management procedure 410, the network node 110 and the UE 120 may communicate to perform beam management using SSB transmissions or CSI-RS transmissions. The beam management procedure 410 (for example, P2 beam management) may be a beam refinement procedure, a network node beam refinement procedure, or a transmit beam refinement procedure, among other examples. As shown in FIG. 4, in beam management procedure 410, SSBs or CSI-RSs may be configured to be transmitted from the network node 110 to the UE 120. The SSBs may be periodic, and the CSI-RSs may be configured to be aperiodic (for example, using DCI). The beam management procedure 410 may include the network node 110 performing a beam sweep over one or more transmit beams. The one or more transmit beams may be a subset of all transmit beams associated with the network node 110 (for example, determined according to measurements reported by the UE 120 in connection with the first beam management procedure). The network node 110 may transmit an SSB or a CSI-RS using each transmit beam of the one or more transmit beams for beam management. The UE 120 may measure each SSB or CSI-RS using a single (for example, a same) receive beam (for example, determined according to measurements performed in connection with the beam management procedure 400). The beam management procedure 410 may enable the network node 110 to select a best transmit beam according to measurements of the SSBs or CSI-RSs (for example, measured by the UE 120 using the single receive beam) reported by the UE 120.

As shown in FIG. 4, beam management procedure 420 (for example, P3 beam management) may be a beam refinement procedure, a UE beam refinement procedure, a receive beam refinement procedure, or a UE beam management procedure, among other examples. As shown in FIG. 4, in beam management procedure 420, one or more SSBs or CSI-RSs may be configured to be transmitted from the network node 110 to the UE 120. The SSBs may be configured to be periodic, and the CSI-RSs may be configured to be aperiodic (for example, using DCI). The beam management procedure 420 may include the network node 110 transmitting the one or more SSBs or CSI-RSs using a single transmit beam (for example, determined according to measurements reported by the UE 120 in connection with the first beam management procedure or the second beam management procedure). To enable the UE 120 to perform receive beam sweeping, the network node 110 may use a transmit beam to transmit (for example, with repetitions) an SSB or CSI-RS at multiple times within the same reference signal resource set such that UE 120 can sweep through one or more receive beams in multiple transmission instances. The one or more receive beams may be a subset of all receive beams associated with the UE 120 (for example, determined according to measurements performed in connection with the beam management procedure 400 or the beam management procedure 410). The beam management procedure 420 may enable the UE 120 to select a best receive beam according to measurements of the SSBs or CSI-RSs or may enable the network node 110 to select a best receive beam for the UE 120 according to reported measurements received from the UE 120 (for example, measurements of the SSB or CSI-RS using the one or more receive beams).

As indicated above, FIG. 4 is provided as an example. Other examples may differ from what is described with regard to FIG. 4.

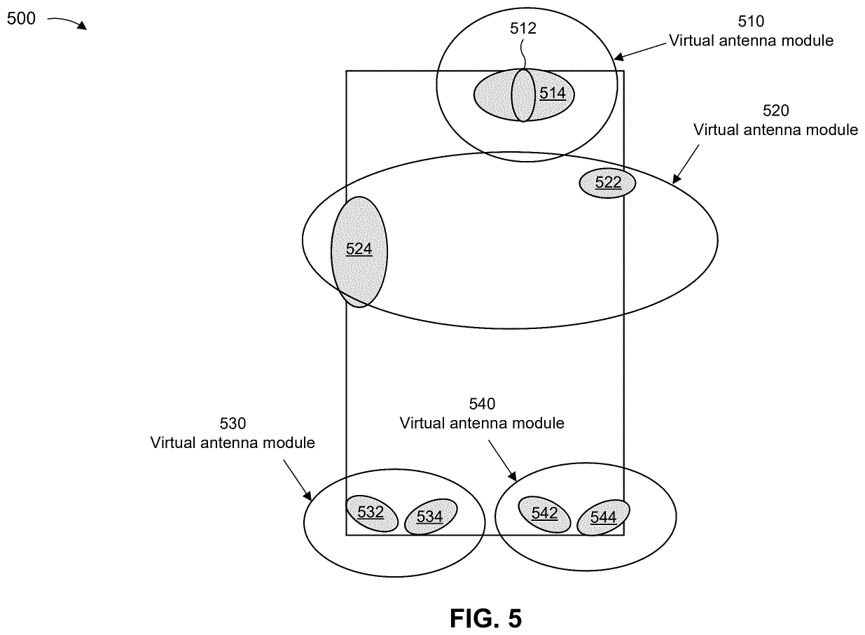

FIG. 5 is a diagram illustrating an example 500 associated with analog beamforming for discrete antennas. As described herein, analog beamforming includes techniques that use phase shifters, amplitude control, or other techniques to co-phase antenna elements to improve radio performance, mitigate path loss, combat fading, increase throughput and reliability, or otherwise improve performance at a desired RF. Analog beamforming is typically used to improve a link budget at mmWave frequencies (e.g., in FR2, which includes frequencies from 24.25 GHz through 52.6 GHz), where communication at high operating frequencies and shorter wavelengths may be impaired by increased blockage, penetration, and path loss. Accordingly, in FR2 or other mmWave frequencies, analog beamforming techniques are often used to transmit and receive directional signals using antennas that are grouped across polarizations in an antenna module design. Although analog beamforming may similarly improve performance at other frequencies, such as frequencies in FR1 (e.g., from 410 MHz) or FR3 (e.g., from 7.125 GHz through 24.25 GHz), extending analog beamforming techniques to such frequencies poses challenges due to the antenna configurations that are typically used at such frequencies. For example, communication in FR1, FR3, or other sub-mmWave frequencies often use PIFA elements, where a PIFA is a compact antenna structure in which a portion of the antenna is folded over itself and grounded to optimize space and enhance performance. Although PIFAs can be designed to support dual polarizations, practical PIFA designs are often monopoles because dual polarized PIFA designs occupy more area and often do not support wideband applications.

Furthermore, constructing antenna groups that can be co-phased to support analog beamforming can be cumbersome, due to significant search and overhead. For example, analog beamforming can be supported with different antenna elements with associated channels that have high cross-correlation coefficients that vary slowly over time. With antenna elements that have high cross-correlation coefficients, analog beamforming coefficients or weights determined at measurement time can then provide a significant array gain during a reasonable time interval following the measurement time. Antenna elements within an antenna module (or panel) typically have high cross-correlation coefficients that support analog beamforming due to antenna elements having spatial proximity and the same or similar directivity patterns and polarizations. However, antenna elements designed for FR1, FR3, or other sub-mmWave frequencies typically do not have high cross-correlation coefficients, are often placed such that associated channels are uncorrelated to achieve a high diversity gain through antenna selection, and are typically not oriented to point in any particular direction (e.g., the antenna elements are typically used for omnidirectional communication).

Accordingly, some aspects described herein relate to techniques to enable analog beamforming with discrete antennas, such as antenna elements that are associated with different antenna modules, uncorrelated channels, monopoles, or low cross-correlation coefficients, among other examples. For example, a UE equipped with multiple discrete or uni-polarized antenna elements may be configured to disable one or more RF chains (e.g., to conserve power), and may implement analog beamforming to coherently combine multiple antennas over the remaining RF chains to compensate for a loss in a data rate or to otherwise maintain a downlink or uplink margin. For example, a UE 120 equipped with four Rx chains may disable two Rx chains to conserve power, and may coherently combine multiple antennas over the two RF chains that remain turned on. For example, FIG. 5 depicts an example antenna configuration for a UE 120 equipped with multiple RF chains associated with discrete antenna elements that may serve various frequencies or frequency ranges, such as FR1 and FR3 (e.g., the antennas may support communication at 3.8 GHz, 7.125-8 GHz, 13 GHz, or other suitable frequencies). Accordingly, the UE 120 may turn off one or more RF chains to save power, and remaining antenna elements may be combined at a desired RF using analog beamforming weights to control phase shifts, amplitudes, or other suitable parameters for co-phasing multiple antenna elements over one or more layers.

For example, FIG. 5 illustrates an analog beamforming configuration where the UE 120 combines 8 discrete antennas over 4 ports, with two antenna elements combined in an analog domain per port. For example, a first virtual antenna module 510 corresponding to a first port combines antenna elements 512 and 514, a second virtual antenna module 520 corresponding to a second port combines antenna elements 522 and 524, a third virtual antenna module 530 corresponding to a third port combines antenna elements 532 and 534, and a fourth virtual antenna module 540 corresponding to a fourth port combines antenna elements 542 and 544. Furthermore, although FIG. 5 illustrates one example analog beamforming configuration, the number of layers and the number of antenna elements that are combined for analog beamforming per layer may vary according to an implementation associated with the UE 120 or power-performance tradeoffs (e.g., more antennas may be used to increase performance, or fewer antennas may be used to reduce power consumption). For example, the number of layers and the number of antenna elements that are combined for analog beamforming may relate to a target performance improvement, a target power reduction, or a target search complexity with respect to an antenna combination or beam weights to be used, among other examples. Furthermore, because there could be many antenna elements available at the UE 120, analog beamforming with discrete antennas may provide a large number of degrees of freedom in terms of performance improvement, power reduction, or thermal management (e.g., where increased power consumption increases heat).

As indicated above, FIG. 5 is provided as an example. Other examples may differ from what is described with regard to FIG. 5.

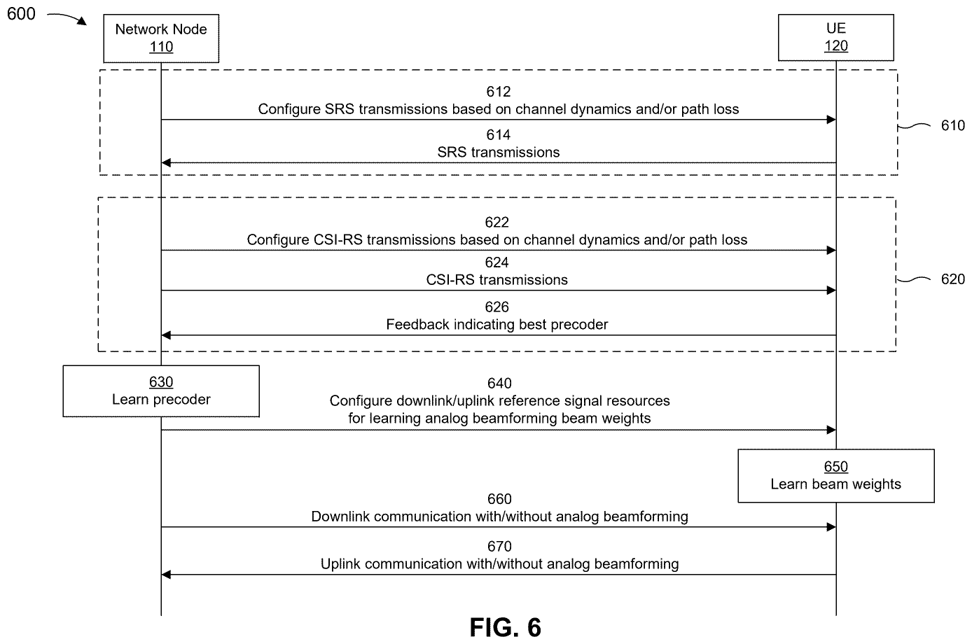

FIG. 6 is a diagram illustrating an example 600 associated with learning beam weights for analog beamforming with discrete antennas. As shown in FIG. 6, example 600 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

As described herein, example 600 relates to signaling between the network node 110 and the UE 120 to learn beam weights and configure analog beamforming using one or more virtual antenna modules that combine multiple discrete antenna elements (e.g., as described in more detail above with reference to FIG. 5).

For example, as shown by reference number 610, the network node 110 and the UE 120 may learn beam weights for analog beamforming with discrete antennas according to SRS transmissions by the UE 120. For example, as shown by reference number 612, the network node 110 may transmit, and the UE 120 may receive, a reference signal configuration that configures one or more SRS resources for one or more SRS transmissions, which may be periodic, aperiodic, or semi-persistent. In some aspects, the network node 110 may configure the SRS resources according to channel dynamics, path loss, or other characteristics associated with a wireless channel between the network node 110 and the UE 120. As shown by reference number 614, the UE 120 may then transmit, and the network node 110 may receive, one or more SRS transmissions in accordance with the reference signal configuration. In some aspects, the UE 120 may transmit the one or more SRS transmissions on an uplink with or without analog beamforming. In some aspects, the network node 110 may configure the SRS resources to learn the analog beamforming weights according to uplink SRS transmissions in cases where the UE 120 is near the network node 110 or located around the middle of a cell associated with the network node 110 (e.g., where the UE 120 can transmit the SRS transmissions with sufficient power to enable the network node 110 to estimate the characteristics of the wireless channel).

Alternatively, as shown by reference number 620, the network node 110 and the UE 120 may learn beam weights for analog beamforming with discrete antennas according to downlink CSI-RS transmissions by the network node 110. For example, as shown by reference number 622, the network node 110 may transmit, and the UE 120 may receive, a reference signal configuration that configures one or more CSI-RS resources for one or more CSI-RS transmissions, which may be periodic, aperiodic, or semi-persistent. In some aspects, the network node 110 may configure the CSI-RS resources according to channel dynamics, path loss, or other characteristics associated with a wireless channel between the network node 110 and the UE 120. As shown by reference number 624, the network node 110 may then transmit, and the UE 120 may receive, one or more CSI-RS transmissions in accordance with the reference signal configuration. As shown by reference number 626, the UE 120 may then transmit, and the network node 110 may receive, feedback indicating one or more best precoders according to measurements associated with the one or more CSI-RS transmissions. In some aspects, the network node 110 may configure the CSI-RS resources to learn the analog beamforming weights according to downlink CSI-RS transmissions in cases where the UE 120 is relatively far from the network node 110 or located around or near the edge of a cell associated with the network node 110 (e.g., where SRS transmissions by the UE 120 may not reach the network node 110 with sufficient power to enable channel estimation, and the network node 110 has a capability to transmit the CSI-RS transmissions with a higher power than the UE 120 can transmit the SRS transmissions).

Accordingly, as shown by reference number 630, the network node 110 may identify one or more precoders for downlink communication with the UE 120. Additionally, as shown by reference number 640, the network node 110 may transmit, and the UE 120 may receive, a configuration indicating downlink or uplink reference signal resources to learn beam weights for analog beamforming by the UE 120. As shown by reference number 650, the UE 120 may learn the beam weights for analog beamforming according to measurements associated with downlink or uplink reference signals transmitted using the configured reference signal resources. For example, in some aspects, the UE 120 may perform a search to identify one or more suitable antenna configurations in which antenna elements are combined into virtual modules or to identify optimal beam weights for each antenna configuration according to a target performance metric, power metric, thermal metric, or other suitable parameter(s). As shown by reference number 660, the UE 120 and the network node 110 may then communicate on a downlink with or without analog beamforming by the UE 120. Additionally, or alternatively, as shown by reference number 670, the UE 120 and the network node 110 may communicate on an uplink with or without analog beamforming.

As described herein, in order to enable downlink or uplink communication that uses analog beamforming, the UE 120 may learn the optimal antenna configuration and corresponding beam weights (e.g., phase shift, amplitude, or other controls) to balance power-performance tradeoffs. For example, in mmWave communication in FR2, a network node 110 may indicate a spatial QCL relationship to a UE 120 (e.g., a QCL Type D indication) to assist the UE 120 with identifying the beam weights to use for analog beamforming according to a reference signal configuration. For example, as described herein, a QCL relationship, mapping, or configuration between one or more signals (e.g., reference signals, such as an SSB, CSI-RS, SRS, or the like) to a relationship between the antenna ports (and corresponding beams) associated with the respective signal transmissions. For example, different transmissions that share the same antenna port generally experience the same wireless channel, and a QCL relationship may apply to transmissions from different antenna ports that experience radio channels that share certain characteristics (e.g., a Doppler shift, Doppler spread, average delay, delay spread, or spatial reception parameter). In particular, two antenna ports are generally considered to be QCLed when properties associated with a channel over which a symbol on one antenna port is conveyed can be inferred from a channel over which a symbol on the antenna port is conveyed. For example, a PDSCH and a downlink reference signal (e.g., a CSI-RS) may be QCLed, or may have a spatial relationship, in that the beam properties associated with the PDSCH can be derived from the beam properties associated with the downlink reference signal. In other words, the beam weights that are obtained from measurements associated with one or more reference signals can be used to derive the beam weights for another signal or channel that is QCLed with the one or more reference signals.

However, as described herein, QCL indications are typically provided only for communication in FR2 or mmWave frequencies where analog beamforming is typically implemented. On the other hand, in FR1 and other sub-mmWave frequencies, the best antennas are typically selected per layer, and existing signaling frameworks do not support indicating a spatial QCL relationship for analog beamforming with discrete antennas (e.g., where antenna elements are combined in virtual modules). Accordingly, some aspects described herein relate to a signaling framework to indicate a spatial QCL relationship to a UE 120 that supports analog beamforming with discrete antennas, which may allow the UE 120 to perform analog beamforming in FR1, FR3, and other frequencies where antenna elements are typically selected per layer.

Furthermore, in cases where a UE 120 enables analog beamforming with discrete antennas to improve performance, reduce power, or the like, power consumption and thermal impact (as well as performance) may generally increase as more antenna elements are used. For example, different antenna elements may be associated with different RF integrated circuit chips, and different components may be turned off or disabled on different radio frequency integrated circuit (RFIC) chips to enable analog beamforming. As a result, growth in actual power consumption versus the number of active antennas may be a function of the RF architecture associated with a UE 120. Furthermore, a rate at which power consumption and thermal impacts grow may vary depending on whether analog beamforming is implemented for transmission or reception, because different components within an RF integrated circuit chip may be turned on to support transmission versus reception. Accordingly, some aspects described herein relate to techniques whereby a UE 120 may signal one or more limitations regarding an analog beamforming configuration, such as a maximum number of antennas that are combined in an analog beamforming mode, and a network node 110 configures reference signal resources for learning beam weights for analog beamforming in accordance with the one or more limitations signaled by the UE 120.

As indicated above, FIG. 6 is provided as an example. Other examples may differ from what is described with regard to FIG. 6.

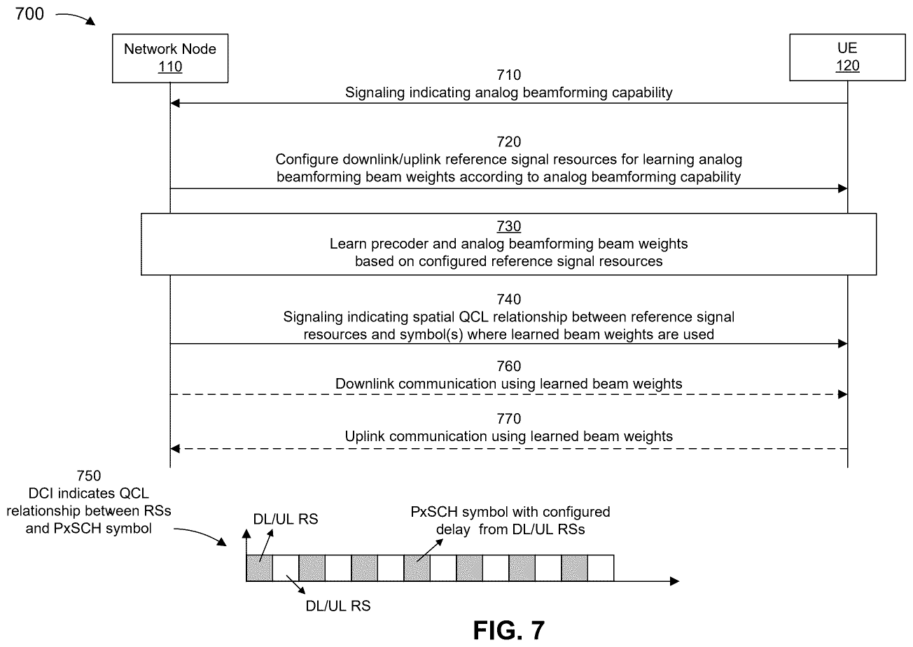

FIG. 7 is a diagram illustrating an example 700 associated with a spatial QCL relationship for analog beamforming with discrete antennas. As shown in FIG. 7, example 700 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

As shown by reference number 710, the UE 120 may transmit, and the network node 110 may receive, signaling that indicates an analog beamforming capability associated with the UE 120. For example, the UE 120 may transmit the signaling to indicate that the UE 120 supports analog beamforming, and may transmit the signaling to indicate that the UE 120 has enabled an analog beamforming mode. In some aspects, the analog beamforming capability may be a static capability that the UE 120 indicates in a capability message associated with connecting to the network node 110 (e.g., during a random access channel (RACH) procedure, when entering a connected mode, or at boot-up or start-up). Additionally, or alternatively, the analog beamforming capability may be a dynamic capability that the UE 120 indicates to the network node 110 when the UE 120 activates or otherwise enables the analog beamforming mode or to request activating the analog beamforming mode (e.g., to balance power-performance tradeoffs).

In some aspects, the analog beamforming capability signaling may additionally indicate one or more analog beamforming parameters. For example, in some aspects, the analog beamforming capability signaling may indicate a number of layers to use with analog beamforming and a number of antennas that are combined in an RF or analog domain over each layer. Additionally, or alternatively, the analog beamforming capability signaling may indicate a delay between a time when the UE 120 learns beam weights for analog beamforming and a time when the UE 120 can program the beam weights on RF hardware to enable downlink or uplink communication using the learned beam weights.

In some aspects, the analog beamforming capability signaling may indicate one or more antenna limitations that are applicable at the UE 120 in the analog beamforming mode. For example, the UE 120 may generally be equipped with N antennas, and may have K RF chains that are active at any given point in time (e.g., the UE 120 may be equipped with 10 antennas, with two RF chains active at a particular time). In some aspects, to manage power and thermal conditions at the UE 120, the UE 120 may determine a maximum number of antennas that can be used for analog beamforming at a given time (e.g., no more than M antennas, where M≤N/K), and may indicate how many antennas can be used over each RF chain to the network node 110. For example, in a configuration where the UE 120 is equipped with K=10 antennas and N=2 active RF chains, the UE 120 may indicate that no more than M=3 antennas can be active for analog beamforming per RF chain. In other examples, the UE 120 may indicate that no more than M=4 or M=5 antennas can be active for analog beamforming per RF chain where the UE 120 has more available power or there is low thermal impact, or that no more than M=2 antennas can be active for analog beamforming per RF chain where the UE 120 has less available power or there is a more severe thermal impact to mitigate. Additionally, or alternatively, the UE 120 may indicate the limitations on the maximum number of antennas per RF chain (or layer) due to hardware constraints. For example, certain antenna elements that are located close to one another may be used for analog beamforming without significant switching or feedline losses that may otherwise limit how many antennas can be gainfully combined.

Alternatively, in some aspects, the network node 110 may indicate how many antennas to use per RF chain to the UE 120 (e.g., in accordance with network conditions).

As shown by reference number 720, the network node 110 may transmit, and the UE 120 may receive, a reference signal configuration that configures periodic, aperiodic, or semi-persistent downlink reference signal resources, uplink reference signal resources, or downlink and uplink reference signal resources for learning beam weights for analog beamforming in accordance with the analog beamforming capability indicated by the UE 120. For example, analog beamforming performance may generally increase with increased accuracy for learning beam weights according to CSI associated with a link between the network node 110 and the UE 120. Accordingly, in some aspects, the network node 110 may use the analog beamforming capability indicated by the UE 120 to configure an appropriate number of downlink or uplink reference signals to allow the UE 120 to derive the beam weights to perform analog beamforming (e.g., where over-provisioning downlink or uplink reference signals may increase the overhead associated with CSI learning, which may limit how many antennas can be combined in analog beamforming, and under-provisioning reference signal resources may provide insufficient resources to enable robust analog beamforming performance). For example, in some aspects, the network node 110 may configure a number of reference signals corresponding to a number of RF chains that are active at a given time, and may configure a respective number of repetitions for each reference signal that is proportional to the number of antenna elements per RF chain.

As shown by reference number 730, the network node 110 may learn one or more precoders for communicating with the UE 120, and the UE 120 may learn the beam weights for analog beamforming, in accordance with measurements associated with one or more reference signal transmissions. For example, in some aspects, the reference signal resources configured by the network node 110 may include SRS resources on an uplink, in which case the UE 120 may transmit one or more SRS repetitions using the SRS resources with different candidate analog beamforming weights, and the network node 110 may select the best set of beam weights for analog beamforming in accordance with measurements of the SRS repetition(s) associated with the different candidate analog beamforming weights. Additionally, or alternatively, the reference signal resources configured by the network node 110 may include CSI-RS resources on a downlink, in which case the network node 110 may transmit one or more CSI-RS repetitions using the CSI-RS resources, and the UE 120 may learn the beam weights for analog beamforming in accordance with measurements of the CSI-RS repetition(s) (e.g., in a similar manner as described above with reference to one or more beam management procedures in FIG. 4). In some aspects, the beam weights for analog beamforming may be learned according to a CIR that the UE 120 estimates over the antenna elements to be combined, and selecting an optimal choice over an entire frequency allocation according to performance, power, thermal, or other parameters.

As shown by reference number 740, the network node 110 may transmit, and the UE 120 may receive, signaling that indicates a spatial QCL relationship (e.g., a QCL Type D mapping, or QCL relationship for a spatial filtering parameter) between one or more reference signals that were allocated for learning the beam weights for analog beamforming and one or more downlink symbols where the beam weights are used to receive a downlink communication (e.g., a PDSCH) or one or more uplink symbols where the beam weights are used to transmit an uplink communication (e.g., a PUSCH). Furthermore, the network node 110 may configure a delay between the one or more reference signals associated with the QCL relationship and the downlink or uplink symbol(s) where the beam weights are used to receive or send a transmission. For example, the delay between the one or more reference signals and the downlink or uplink symbol(s) associated with the QCL relationship may be associated with the analog beamforming capability indicated by the UE 120 (e.g., related to how long the UE 120 takes to program beam weights for analog beamforming on RF hardware).

For example, as shown by reference number 750, the spatial QCL relationship may be indicated in a DCI message. For example, in a use case where the UE 120 uses a 1Rx (one RF chain for reception) analog beamforming capability with 4 discrete antennas, the spatial QCL relationship may be indicated between 4 downlink or uplink reference signals and at least one PxSCH (e.g., PDSCH or PUSCH) data symbol. Alternatively, in a use case where the UE 120 uses a 2Rx analog beamforming capability with 4 discrete antennas, the spatial QCL relationship may be indicated between 2 downlink or uplink reference signals and at least one data symbol. Accordingly, as shown by reference number 750, the DCI indicating the spatial QCL relationship may indicate a delay between the one or more reference signals used to learn beam weights for analog beamforming and the PxSCH symbol where the beam weights are used in accordance with the analog beamforming capability of the UE 120.

In some aspects, to indicate the spatial QCL relationship associated with the PxSCH beams to the UE 120, the DCI may indicate a codepoint associated with one or more TCI states. For example, the one or more TCI states associated with the QCL relationship may correspond to downlink TCI states or joint downlink and uplink TCI states configured at the network node 110 for the reference signals that were used to learn the beam weights for analog beamforming. Additionally, or alternatively, the one or more TCI states associated with the QCL relationship may correspond to uplink TCI states or joint downlink and uplink TCI states configured at the UE 120 for the reference signals that were used to learn the beam weights for analog beamforming. In some aspects, the one or more TCI states indicated by the DCI codepoint may include at least one TCI state associated with a spatial QCL relationship. Furthermore, for PxSCH communication with L layers in FR1, the DCI codepoint may identity at least L TCI states that each provide a spatial QCL relationship between one or more reference signals and a PxSCH (e.g., in contrast to FR2, where the antenna elements are dual polarized, such that the DCI codepoint may indicate only ┌L/2┐ TCI states that each provide a spatial QCL relationship). In some aspects, the DCI codepoint may identify three or more TCI states, and the DCI codepoint may be valid for downlink and uplink communication until a new DCI with a different codepoint is received.

Accordingly, as described herein, the spatial QCL relationship may be used for PDSCH or PUSCH communication. For example, as shown by reference number 760, the UE 120 and the network node 110 may communicate on a downlink using the beam weights learned for analog beamforming in accordance with one or more TCI states that provide a spatial QCL relationship between one or more reference signals used to learn the beam weights and one or more PDSCH transmissions that use the beam weights. Additionally, or alternatively, as shown by reference number 770, the UE 120 and the network node 110 may communicate on an uplink using the beam weights learned for analog beamforming in accordance with one or more TCI states that provide a spatial QCL relationship between one or more reference signals used to learn the beam weights and one or more PUSCH transmissions that use the beam weights.

As indicated above, FIG. 7 is provided as an example. Other examples may differ from what is described with regard to FIG. 7.

FIG. 8 is a diagram illustrating an example process 800 performed, for example, at a UE or an apparatus of a UE. Example process 800 is an example where the apparatus or the UE (e.g., UE 120) performs operations associated with techniques for spatial QCL relationship for analog beamforming with discrete antennas.

As shown in FIG. 8, in some aspects, process 800 may include transmitting, to a network node, signaling indicating an analog beamforming capability associated with the UE (block 810). For example, the UE (e.g., using transmission component 1004 or communication manager 1006, depicted in FIG. 10) may transmit, to a network node, signaling indicating an analog beamforming capability associated with the UE, as described above.

As further shown in FIG. 8, in some aspects, process 800 may include receiving, from the network node, a reference signal configuration in accordance with the analog beamforming capability associated with the UE, wherein the reference signal configuration indicates a spatial QCL relationship between one or more reference signals for learning beam weights and one or more transmissions that use the beam weights (block 820). For example, the UE (e.g., using reception component 1002 or communication manager 1006, depicted in FIG. 10) may receive, from the network node, a reference signal configuration in accordance with the analog beamforming capability associated with the UE, wherein the reference signal configuration indicates a spatial QCL relationship between one or more reference signals for learning beam weights and one or more transmissions that use the beam weights, as described above.

Process 800 may include additional aspects, such as any single aspect or any combination of aspects described below or in connection with one or more other processes described elsewhere herein.

In a first aspect, the analog beamforming capability is a static capability indicated in a capability message associated with connecting to the network node.

In a second aspect, alone or in combination with the first aspect, the analog beamforming capability is a dynamic capability indicated in accordance with activating the analog beamforming capability for power-performance tradeoffs.

In a third aspect, alone or in combination with one or more of the first and second aspects, the signaling includes a request to activate the analog beamforming capability.

In a fourth aspect, alone or in combination with one or more of the first through third aspects, the signaling indicates a number of layers associated with the analog beamforming capability and a number of antennas that are combined in a radio frequency or analog domain over each of the number of layers.

In a fifth aspect, alone or in combination with one or more of the first through fourth aspects, the signaling indicates a time delay between learning the beam weights to support the analog beamforming capability and programming the beam weights on one or more RF components.

In a sixth aspect, alone or in combination with one or more of the first through fifth aspects, the reference signal configuration indicates one or more of a number of reference signals or a respective number of repetitions for each of the number of reference signals in accordance with the analog beamforming capability.

In a seventh aspect, alone or in combination with one or more of the first through sixth aspects, a delay between the one or more reference signals for learning the beam weights and the one or more transmissions that use the beam weights is associated with the analog beamforming capability.

In an eighth aspect, alone or in combination with one or more of the first through seventh aspects, process 800 includes communicating with the network node to configure the beam weights in accordance with the reference signal configuration, and receiving, from the network node, a DCI codepoint that indicates one or more TCI states associated with the spatial QCL relationship.

In a ninth aspect, alone or in combination with one or more of the first through eighth aspects, process 800 includes receiving, from the network node, the one or more transmissions that use the beam weights in accordance with the spatial QCL relationship associated with the one or more TCI states.

In a tenth aspect, alone or in combination with one or more of the first through ninth aspects, process 800 includes transmitting, to the network node, the one or more transmissions that use the beam weights in accordance with the spatial QCL relationship associated with the one or more TCI states.

In an eleventh aspect, alone or in combination with one or more of the first through tenth aspects, a number of the one or more TCI states that are associated with the spatial QCL relationship is based on an antenna polarization for a frequency range associated with the one or more transmissions.

In a twelfth aspect, alone or in combination with one or more of the first through eleventh aspects, the DCI codepoint indicates three or more TCI states associated with the spatial QCL relationship.

In a thirteenth aspect, alone or in combination with one or more of the first through twelfth aspects, the analog beamforming capability includes a maximum number of antenna elements available for analog beamforming.

In a fourteenth aspect, alone or in combination with one or more of the first through thirteenth aspects, the maximum number of antenna elements available for analog beamforming satisfies a threshold based on a total number of antenna elements and a number of active RF chains.

In a fifteenth aspect, alone or in combination with one or more of the first through fourteenth aspects, the reference signal configuration indicates one or more of downlink reference signal resources or uplink reference signal resources associated with learning the beam weights to use for analog beamforming.

In a sixteenth aspect, alone or in combination with one or more of the first through fifteenth aspects, process 800 includes receiving, from the network node, information indicating a number of antenna elements to use for analog beamforming per RF chain in accordance with the analog beamforming capability.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with a spatial QCL relationship for analog beamforming with discrete antennas.

As shown in FIG. 9, in some aspects, process 900 may include receiving, from a UE, signaling indicating an analog beamforming capability associated with the UE (block 910). For example, the network node (e.g., using reception component 1102 or communication manager 1106, depicted in FIG. 11) may receive, from a UE, signaling indicating an analog beamforming capability associated with the UE, as described above.

As further shown in FIG. 9, in some aspects, process 900 may include transmitting, to the UE, a reference signal configuration in accordance with the analog beamforming capability associated with the UE, wherein the reference signal configuration indicates a spatial QCL relationship between one or more reference signals for learning beam weights and one or more transmissions that use the beam weights (block 920). For example, the network node (e.g., using transmission component 1104 or communication manager 1106, depicted in FIG. 11) may transmit, to the UE, a reference signal configuration in accordance with the analog beamforming capability associated with the UE, wherein the reference signal configuration indicates a spatial QCL relationship between one or more reference signals for learning beam weights and one or more transmissions that use the beam weights, as described above.

Process 900 may include additional aspects, such as any single aspect or any combination of aspects described below or in connection with one or more other processes described elsewhere herein.

In a first aspect, the analog beamforming capability is a static capability indicated in a capability message associated with connecting to the network node.

In a second aspect, alone or in combination with the first aspect, the analog beamforming capability is a dynamic capability indicated in accordance with activating the analog beamforming capability for power-performance tradeoffs.

In a third aspect, alone or in combination with one or more of the first and second aspects, the signaling includes a request to activate the analog beamforming capability.

In a fourth aspect, alone or in combination with one or more of the first through third aspects, the signaling indicates a number of layers associated with the analog beamforming capability and a number of antennas that are combined in a RF or analog domain over each of the number of layers.

In a fifth aspect, alone or in combination with one or more of the first through fourth aspects, the signaling indicates a time delay between learning the beam weights to support the analog beamforming capability and programming the beam weights on one or more RF components.

In a sixth aspect, alone or in combination with one or more of the first through fifth aspects, the reference signal configuration indicates one or more of a number of reference signals or a respective number of repetitions for each of the number of reference signals in accordance with the analog beamforming capability.

In a seventh aspect, alone or in combination with one or more of the first through sixth aspects, a delay between the one or more reference signals for learning the beam weights and the one or more transmissions that use the beam weights is associated with the analog beamforming capability.

In an eighth aspect, alone or in combination with one or more of the first through seventh aspects, process 900 includes communicating with the UE to configure the beam weights in accordance with the reference signal configuration, and transmitting, to the UE, a DCI codepoint that indicates one or more TCI states associated with the spatial QCL relationship.

In a ninth aspect, alone or in combination with one or more of the first through eighth aspects, process 900 includes transmitting, to the UE, the one or more transmissions that use the beam weights in accordance with the spatial QCL relationship associated with the one or more TCI states.

In a tenth aspect, alone or in combination with one or more of the first through ninth aspects, process 900 includes receiving, from the UE, the one or more transmissions that use the beam weights in accordance with the spatial QCL relationship associated with the one or more TCI states.

In an eleventh aspect, alone or in combination with one or more of the first through tenth aspects, a number of the one or more TCI states that are associated with the spatial QCL relationship is based on an antenna polarization for a frequency range associated with the one or more transmissions.

In a twelfth aspect, alone or in combination with one or more of the first through eleventh aspects, the DCI codepoint indicates three or more TCI states associated with the spatial QCL relationship.

In a thirteenth aspect, alone or in combination with one or more of the first through twelfth aspects, the analog beamforming capability includes a maximum number of antenna elements available for analog beamforming.

In a fourteenth aspect, alone or in combination with one or more of the first through thirteenth aspects, the maximum number of antenna elements available for analog beamforming satisfies a threshold based on a total number of antenna elements and a number of active RF chains.

In a fifteenth aspect, alone or in combination with one or more of the first through fourteenth aspects, the reference signal configuration indicates one or more of downlink reference signal resources or uplink reference signal resources associated with learning the beam weights to use for analog beamforming.

In a sixteenth aspect, alone or in combination with one or more of the first through fifteenth aspects, process 900 includes transmitting, to the UE, information indicating a number of antenna elements to use for analog beamforming per RF chain in accordance with the analog beamforming capability.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE 120, or a UE 120 may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE 120 or a network node 110 (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE 120.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE 120 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE 120 described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a network node, signaling indicating an analog beamforming capability associated with the UE. The reception component 1002 may receive, from the network node, a reference signal configuration in accordance with the analog beamforming capability associated with the UE, wherein the reference signal configuration indicates a spatial QCL relationship between one or more reference signals for learning beam weights and one or more transmissions that use the beam weights.

The number and arrangement of components shown in FIG. 10 are provided as an example. In practice, there may be additional components, fewer components, different components, or differently arranged components than those shown in FIG. 10.

Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node 110, or a network node 110 may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE 120 or a network node 110 (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node 110.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network node 110 described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive, from a UE 120, signaling indicating an analog beamforming capability associated with the UE 120. The transmission component 1104 may transmit, to the UE 120, a reference signal configuration in accordance with the analog beamforming capability associated with the UE 120, wherein the reference signal configuration indicates a spatial QCL relationship between one or more reference signals for learning beam weights and one or more transmissions that use the beam weights.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a UE, comprising: transmitting, to a network node, signaling indicating an analog beamforming capability associated with the UE; and receiving, from the network node, a reference signal configuration in accordance with the analog beamforming capability associated with the UE, wherein the reference signal configuration indicates a spatial QCL relationship between one or more reference signals for learning beam weights and one or more transmissions that use the beam weights.
Aspect 2: The method of Aspect 1, wherein the analog beamforming capability is a static capability indicated in a capability message associated with connecting to the network node.
Aspect 3: The method of any of Aspects 1-2, wherein the analog beamforming capability is a dynamic capability indicated in accordance with activating the analog beamforming capability for power-performance tradeoffs.
Aspect 4: The method of any of Aspects 1-3, wherein the signaling includes a request to activate the analog beamforming capability.
Aspect 5: The method of any of Aspects 1-4, wherein the signaling indicates a number of layers associated with the analog beamforming capability and a number of antennas that are combined in a RF or analog domain over each of the number of layers.
Aspect 6: The method of any of Aspects 1-5, wherein the signaling indicates a time delay between learning the beam weights to support the analog beamforming capability and programming the beam weights on one or more RF components.
Aspect 7: The method of any of Aspects 1-6, wherein the reference signal configuration indicates one or more of a number of reference signals or a respective number of repetitions for each of the number of reference signals in accordance with the analog beamforming capability.
Aspect 8: The method of any of Aspects 1-7, wherein a delay between the one or more reference signals for learning the beam weights and the one or more transmissions that use the beam weights is associated with the analog beamforming capability.
Aspect 9: The method of any of Aspects 1-8, further comprising: communicating with the network node to configure the beam weights in accordance with the reference signal configuration; and receiving, from the network node, a DCI codepoint that indicates one or more TCI states associated with the spatial QCL relationship.
Aspect 10: The method of Aspect 9, further comprising: receiving, from the network node, the one or more transmissions that use the beam weights in accordance with the spatial QCL relationship associated with the one or more TCI states.
Aspect 11: The method of Aspect 9, further comprising: transmitting, to the network node, the one or more transmissions that use the beam weights in accordance with the spatial QCL relationship associated with the one or more TCI states.
Aspect 12: The method of Aspect 9, wherein a number of the one or more TCI states that are associated with the spatial QCL relationship is based on an antenna polarization for a frequency range associated with the one or more transmissions.
Aspect 13: The method of Aspect 9, wherein the DCI codepoint indicates three or more TCI states associated with the spatial QCL relationship.
Aspect 14: The method of any of Aspects 1-13, wherein the analog beamforming capability includes a maximum number of antenna elements available for analog beamforming.
Aspect 15: The method of Aspect 14, wherein the maximum number of antenna elements available for analog beamforming satisfies a threshold based on a total number of antenna elements and a number of active RF chains.
Aspect 16: The method of Aspect 14, wherein the reference signal configuration indicates one or more of downlink reference signal resources or uplink reference signal resources associated with learning the beam weights to use for analog beamforming.
Aspect 17: The method of any of Aspects 1-16, further comprising: receiving, from the network node, information indicating a number of antenna elements to use for analog beamforming per RF chain in accordance with the analog beamforming capability.
Aspect 18: A method of wireless communication performed by a network node, comprising: receiving, from a UE, signaling indicating an analog beamforming capability associated with the UE; and transmitting, to the UE, a reference signal configuration in accordance with the analog beamforming capability associated with the UE, wherein the reference signal configuration indicates a spatial QCL relationship between one or more reference signals for learning beam weights and one or more transmissions that use the beam weights.
Aspect 19: The method of Aspect 18, wherein the analog beamforming capability is a static capability indicated in a capability message associated with connecting to the network node.
Aspect 20: The method of any of Aspects 18-19, wherein the analog beamforming capability is a dynamic capability indicated in accordance with activating the analog beamforming capability for power-performance tradeoffs.
Aspect 21: The method of any of Aspects 18-20, wherein the signaling includes a request to activate the analog beamforming capability.
Aspect 22: The method of any of Aspects 18-21, wherein the signaling indicates a number of layers associated with the analog beamforming capability and a number of antennas that are combined in a RF or analog domain over each of the number of layers.
Aspect 23: The method of any of Aspects 18-22, wherein the signaling indicates a time delay between learning the beam weights to support the analog beamforming capability and programming the beam weights on one or more RF components.
Aspect 24: The method of any of Aspects 18-23, wherein the reference signal configuration indicates one or more of a number of reference signals or a respective number of repetitions for each of the number of reference signals in accordance with the analog beamforming capability.
Aspect 25: The method of any of Aspects 18-24, wherein a delay between the one or more reference signals for learning the beam weights and the one or more transmissions that use the beam weights is associated with the analog beamforming capability.
Aspect 26: The method of any of Aspects 18-25, further comprising: communicating with the UE to configure the beam weights in accordance with the reference signal configuration; and transmitting, to the UE, a DCI codepoint that indicates one or more TCI states associated with the spatial QCL relationship.
Aspect 27: The method of Aspect 26, further comprising: transmitting, to the UE, the one or more transmissions that use the beam weights in accordance with the spatial QCL relationship associated with the one or more TCI states.
Aspect 28: The method of Aspect 26, further comprising: receiving, from the UE, the one or more transmissions that use the beam weights in accordance with the spatial QCL relationship associated with the one or more TCI states.
Aspect 29: The method of Aspect 26, wherein a number of the one or more TCI states that are associated with the spatial QCL relationship is based on an antenna polarization for a frequency range associated with the one or more transmissions.
Aspect 30: The method of Aspect 26, wherein the DCI codepoint indicates three or more TCI states associated with the spatial QCL relationship.
Aspect 31: The method of any of Aspects 18-30, wherein the analog beamforming capability includes a maximum number of antenna elements available for analog beamforming.
Aspect 32: The method of Aspect 31, wherein the maximum number of antenna elements available for analog beamforming satisfies a threshold based on a total number of antenna elements and a number of active RF chains.
Aspect 33: The method of Aspect 31, wherein the reference signal configuration indicates one or more of downlink reference signal resources or uplink reference signal resources associated with learning the beam weights to use for analog beamforming.
Aspect 34: The method of any of Aspects 18-33, further comprising: transmitting, to the UE, information indicating a number of antenna elements to use for analog beamforming per RF chain in accordance with the analog beamforming capability.
Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.
Aspect 36: An apparatus for wireless communication at a device, the apparatus comprising one or more memories and one or more processors coupled to the one or more memories, the one or more processors configured to cause the device to perform the method of one or more of Aspects 1-34.
Aspect 37: An apparatus for wireless communication, the apparatus comprising at least one means for performing the method of one or more of Aspects 1-34.
Aspect 38: A non-transitory computer-readable medium storing code for wireless communication, the code comprising instructions executable by one or more processors to perform the method of one or more of Aspects 1-34.
Aspect 39: A non-transitory computer-readable medium storing a set of instructions for wireless communication, the set of instructions comprising one or more instructions that, when executed by one or more processors of a device, cause the device to perform the method of one or more of Aspects 1-34.
Aspect 40: A device for wireless communication, the device comprising a processing system that includes one or more processors and one or more memories coupled with the one or more processors, the processing system configured to cause the device to perform the method of one or more of Aspects 1-34.
Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.
Aspect 42: A device comprising a processing system that includes one or more processors and one or more code-storing memories coupled with the one or more processors, the processing system configured to cause the device to perform the method of one or more of Aspects 1-34.
Aspect 43: A device comprising a processing system that includes processor circuitry and code-storing memory circuitry, the processing system configured to cause the device to perform the method of one or more of Aspects 1-34.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
transmitting, to a network node, signaling indicating an analog beamforming capability associated with the UE; and
receiving, from the network node, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights.

2. The method of claim 1, wherein the analog beamforming capability is a static capability indicated in a capability message associated with connecting to the network node.

3. The method of claim 1, wherein the analog beamforming capability is a dynamic capability indicated in accordance with activating the analog beamforming capability for power-performance tradeoffs.

4. The method of claim 1, wherein the signaling includes a request to activate the analog beamforming capability.

5. The method of claim 1, wherein the signaling indicates a number of layers associated with the analog beamforming capability and a number of antennas that are combined in a radio frequency or analog domain over each of the number of layers.

6. The method of claim 1, wherein the signaling indicates a time delay between learning the beam weights to support the analog beamforming capability and programming the beam weights on one or more radio frequency components.

7. The method of claim 1, wherein the reference signal configuration indicates one or more of a number of reference signals or a respective number of repetitions for each of the number of reference signals in accordance with the analog beamforming capability.

8. The method of claim 1, wherein a delay between the one or more reference signals for learning the beam weights and the one or more transmissions that use the beam weights is associated with the analog beamforming capability.

9. The method of claim 1, further comprising:
communicating with the network node to configure the beam weights in accordance with the reference signal configuration; and
receiving, from the network node, a downlink control information (DCI) codepoint that indicates one or more transmission configuration indicator (TCI) states associated with the spatial QCL relationship.

10. The method of claim 9, further comprising:
receiving, from the network node, the one or more transmissions that use the beam weights in accordance with the spatial QCL relationship associated with the one or more TCI states.

11. The method of claim 9, further comprising:
transmitting, to the network node, the one or more transmissions that use the beam weights in accordance with the spatial QCL relationship associated with the one or more TCI states.

12. The method of claim 9, wherein a number of the one or more TCI states that are associated with the spatial QCL relationship is based on an antenna polarization for a frequency range associated with the one or more transmissions.

13. The method of claim 9, wherein the DCI codepoint indicates three or more TCI states associated with the spatial QCL relationship.

14. The method of claim 1, wherein the analog beamforming capability includes a maximum number of antenna elements available for analog beamforming.

15. The method of claim 14, wherein the maximum number of antenna elements available for analog beamforming satisfies a threshold based on a total number of antenna elements and a number of active radio frequency (RF) chains.

16. The method of claim 14, wherein the reference signal configuration indicates one or more of downlink reference signal resources or uplink reference signal resources associated with learning the beam weights to use for analog beamforming.

17. The method of claim 1, further comprising:
receiving, from the network node, information indicating a number of antenna elements to use for analog beamforming per radio frequency (RF) chain in accordance with the analog beamforming capability.

18. A method of wireless communication performed by a network node, comprising:
receiving, from a user equipment (UE), signaling indicating an analog beamforming capability associated with the UE; and
transmitting, to the UE, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights.

19. The method of claim 18, wherein the analog beamforming capability is a static capability indicated in a capability message associated with connecting to the network node.

20. The method of claim 18, wherein the analog beamforming capability is a dynamic capability indicated in accordance with activating the analog beamforming capability for power-performance tradeoffs.

21. The method of claim 18, wherein the signaling includes a request to activate the analog beamforming capability.

22. The method of claim 18, wherein the signaling indicates a number of layers associated with the analog beamforming capability and a number of antennas that are combined in a radio frequency or analog domain over each of the number of layers.

23. The method of claim 18, wherein the signaling indicates a time delay between learning the beam weights to support the analog beamforming capability and programming the beam weights on one or more radio frequency components.

24. The method of claim 18, wherein the reference signal configuration indicates one or more of a number of reference signals or a respective number of repetitions for each of the number of reference signals in accordance with the analog beamforming capability.

25. The method of claim 18, wherein a delay between the one or more reference signals for learning the beam weights and the one or more transmissions that use the beam weights is associated with the analog beamforming capability.

26. The method of claim 18, further comprising:
communicating with the UE to configure the beam weights in accordance with the reference signal configuration; and
transmitting, to the UE, a downlink control information (DCI) codepoint that indicates one or more transmission configuration indicator (TCI) states associated with the spatial QCL relationship.

27. The method of claim 18, wherein the analog beamforming capability includes a maximum number of antenna elements available for analog beamforming.

28. The method of claim 18, further comprising:
transmitting, to the UE, information indicating a number of antenna elements to use for analog beamforming per radio frequency (RF) chain in accordance with the analog beamforming capability.

29. A user equipment (UE), comprising:
a processing system that includes one or more processors and one or more code-storing memories coupled with the one or more processors, the processing system configured to cause the UE to:
transmit, to a network node, signaling indicating an analog beamforming capability associated with the UE; and
receive, from the network node, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights.

30. A network node, comprising:
a processing system that includes one or more processors and one or more code-storing memories coupled with the one or more processors, the processing system configured to cause the network node to:
receive, from a user equipment (UE), signaling indicating an analog beamforming capability associated with the UE; and
transmit, to the UE, a reference signal configuration in accordance with the analog beamforming capability associated with the UE, wherein the reference signal configuration indicates a spatial quasi co-location (QCL) relationship between one or more reference signals for learning beam weights and one or more transmissions that use the beam weights.
